(19) United States
(12) Patent Application Publication
(10) Pub. No.: US 2006/0209641 A1
(43) Pub. Date: Sep. 21, 2006

(54) Portable media player control panel relocator

(76) Inventor: Amirahmad Navid, Sherman Oaks, CA (US)

Correspondence Address: CHRISTIE, PARKER & HALE, LLP, PO BOX 7068, PASADENA, CA, 91109-7068, US

(21) Appl. No.: 11/084,666

(22) Filed: Mar. 18, 2005

(51) Int. Cl. G11B 21/08

(52) U.S. Cl. 369/30.06; 360/137; 340/825.25; 381/109

(57) ABSTRACT

A control panel relocator device for use with a portable media player that has a built in control panel on a front surface of the device but does not have controls on a top surface. The control panel relocator has a main body portion with an upper surface and a lower surface, interface electronics, a headphone prong and an accessory control prong that extend downwardly from the bottom surface, a plurality of control elements located on the upper surface including at least one of volume control buttons, a play/pause button, a forward button and a reverse button, and a headphone jack. When engaged at the top of the media player device, the control panel relocator device permits a user to control the media player from the top of the portable media player in addition to its front face.

### SUMMARY

The invention relates to portable media players, and more particularly to a control panel relocator for a portable music player.

### BACKGROUND

The continued cost reduction in miniaturized electronics and memory storage has led to the development of media players that store high volumes of media in small spaces. The use of small cassette tape players has been supplanted by CD players, and more recently, MP3 players.

An advantage of the MP3 players is that one can store thousands of songs, photographs, books on tapes, and other digital files in a very small space, and provide a user with the ability to download songs one at a time or in groups from various music download services, and to literally carry around a whole music library and photo album in a user's pocket or backpack.

One popular brand of MP3 player is the iPod®, offered by Apple Computer, of Cupertino, Calif. The iPod® player is about the same size as a pack of standard playing cards, and has a control panel built into the front panel of the player. Earphones or headphones are typically used to listen to the media player device. When a user carries the iPod® player, for example in a pocket, the control panel of the player cannot be conveniently accessed, even though the top of the iPod® player is accessible without removing the player from the user's pocket. Thus, if a user wishes to replay or fast forward within a song, for example, while the media player is being carried in the user's pocket and the control panel is not accessible, the user will need to remove the media player from his/her pocket. This is an added inconvenience, when, for example, the user is engaging in sporting activities, such as snowboarding, skateboarding, and the like.

There accordingly remains a need for a control panel relocator that provides a secondary control panel that will place controls of the media player on another side of the media player which is more accessible to the user while the device is being carried.

### BRIEF DESCRIPTION OF THE DRAWINGS

These and/or other aspects and advantages of the invention will become apparent and more readily appreciated from the following description of the embodiments, taken in conjunction with the accompanying drawings.

FIG. 1 is a front view of an exemplary prior art media player device with a control panel on a front face thereof.

FIG. 2 is a top view of the prior art media player device of FIG. 1.

FIG. 3 is a top view of an exemplary control panel relocator of the invention.

FIG. 4 is a front view of the exemplary control panel relocator of FIG. 3.

FIG. 5 is a left side view of the exemplary control panel relocator of FIG. 3.

FIG. 6 is a front view of the exemplary prior art media player device of FIG. 1 with the exemplary control panel relocator of FIGS. 3-5 prior to being engaged therewith.

FIG. 7 is a perspective view of the exemplary prior art media player device of FIG. 1 with the exemplary control panel relocator of FIGS. 3-5 engaged therewith.

### DETAILED DESCRIPTION OF THE INVENTION

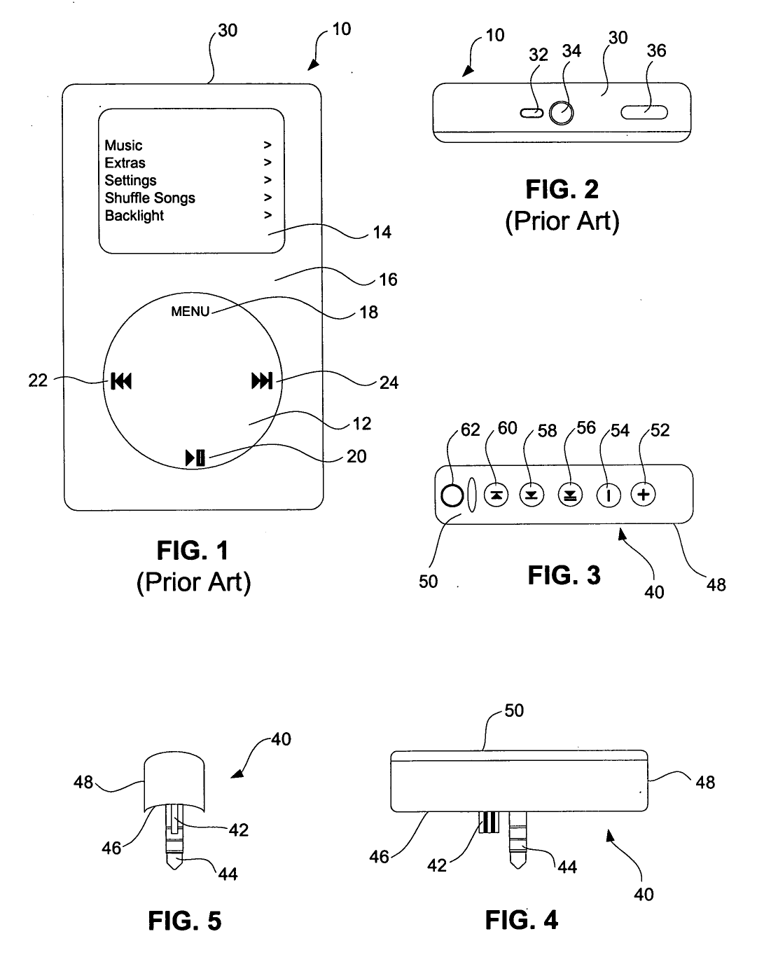

Turning first to FIG. 1, there is shown a front view of an exemplary prior art media player device 10 with a control panel 12 and a display 14 on a front face 16 thereof. The control panel of the exemplary device has a plurality of control elements, e.g., a menu button 18, a play/pause button 20, a rewind button 22 and a fast forward button 24. The menu button and the other button on the control panel are used to provide for navigation of a variety of functions and features on the control panel 14, for example, such as “Music”, “Extras”, “Settings”, “Shuffle Songs” and “Backlight”.

FIG. 2 is a view of the top surface 30 of the prior art media player device 10 of FIG. 1. It has connectors such as a remote port 32 and a headphone jack 34. A hold switch 36 is also optionally provided.

FIGS. 3, 4 and 5 are a top view, a front view, and a left side view, respectively, of an exemplary control panel relocator 40. The control panel relocator 40 is shown as having a remote port prong 42 and a headphone prong 44 extending from a second contact surface 46, e.g., a bottom surface, of a main body portion 48. However, depending upon which media player device the control panel relocator 40 is used with, the number and arrangement of prong and connectors may vary. The remote port prong 42 and the headphone prong 44 are sized and positioned to permit the main body portion 48 to engage with the remote port 32 and the headphone jack 34 of the media player device 10. The bottom surface 46 of the main body portion 48 may be contoured to fit onto the top surface 30 of the media player device 10. The main body portion has a first surface 50, e.g., a top surface, and has a plurality of control elements (e.g., buttons) 52, 54, 56, 58, 60 and 62 that permit various functions and features of the media player device to be activated from the top of the media player. This thereby permits a user to operate various functions and features of media player device 10 from, for example, a user's pocket (not shown.) The control elements can include, for example, an increase volume button 52, a decrease volume button 54, a play/pause button 56, a fast forward button 58 and a reverse button 60. These buttons are representative of the possible control buttons, and can vary depending upon the type of media player device and its intended functions. An accessory headphone jack 62 is also provided. These control buttons are examples of the various features that may be provided on the top surface of the control panel relocator 40. The main body portion 48 includes interface circuitry adapted to permit activation of the control elements of the control panel relocator 40 to control the media player in the same manner as like control elements located on the media player 10. Communication of signals from control panel relocator 40 pass via the remote port prong 42 once engaged with the remote port 32 of the media player device 10. The control panel relocator 40 can be powered either from the media player 10, or can contain its own power supply.

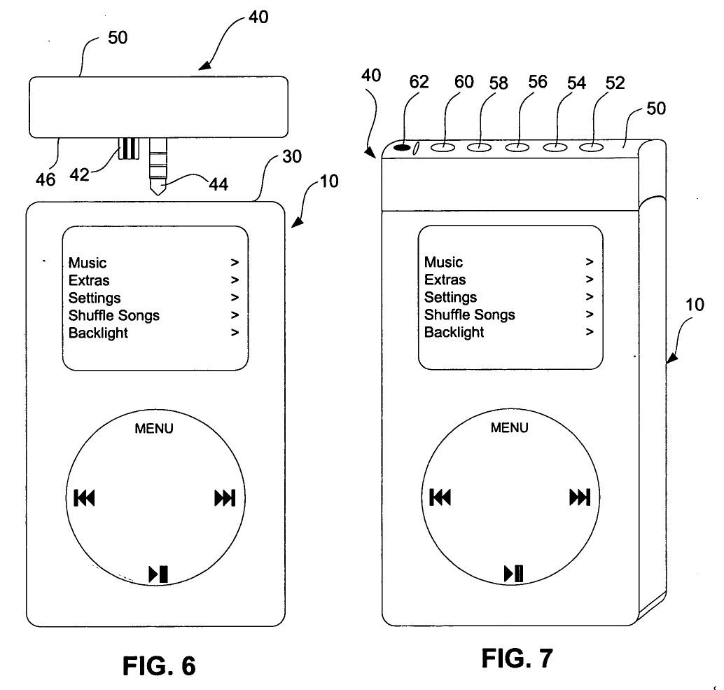

FIG. 6 is a front view of the exemplary control panel relocator 40 of FIGS. 3-5 positioned above and prior to being engaged with the exemplary prior art media player device 10 of FIG. 1.

FIG. 7 is a front perspective view of the exemplary prior art media player device 10 of FIG. 1 with the exemplary control panel relocator 40 of FIGS. 3-5 after being engaged therewith. When so engaged, the control panel relocator 40 permits a user to operate various functions and features of the media player device (e.g. volume control, play/pause, fast forward and reverse from, for example, a user's pocket (not shown.)

Having thus described exemplary embodiments of the present invention, it should be understood by those skilled in the art that the above disclosures are exemplary only and that various other alternatives, adaptations and modifications may be made within the scope of the present invention. The presently disclosed embodiments are to be considered in all respects as illustrative and not restrictive.

What is claimed is:

1. A control panel relocator device for use with a portable media player having at least one connector, the control panel relocator comprising:
a main body portion having a first outside surface and a second outside surface;
interface electronics;
at least one connector on the second outside surface; and
a plurality of control elements located on the first outside surface.

2. The control panel relocator of claim 1, wherein the control elements comprise at least one of volume control buttons, a play/pause button, a forward button and a reverse button.

3. The control panel relocator of claim 1, wherein the at least one connector comprises a headphone prong and an accessory control prong.

4. The control panel relocator of claim 1, further comprising a headphone jack located on the first outside surface.

5. The control panel relocator of claim 1, wherein the first outside surface is an upper surface and the second outside surface is a lower surface.

6. The control panel relocator of claim 5, wherein the interface electronics provides for electrical and logical communication between the control elements and the at least one connector.

7. A control panel relocator device for use with a portable media player having at least one connector, the control panel relocator comprising:
a main body portion having an upper surface and a lower surface;
interface electronics;
a headphone prong and an accessory control prong that extend downwardly from the second outside surface;
a plurality of control elements located on the upper surface comprising at least one of volume control buttons, a play/pause button, a forward button and a reverse button; and
a headphone jack.

8. The control panel relocator of claim 5, wherein the interface electronics provides for electrical and logical communication between the control elements and the at least one connector.
